(19) United States
(12) Patent Application Publication
(10) Pub. No.: US 2025/0285631 A1
(43) Pub. Date: Sep. 11, 2025

(54) AUDIO PROCESSING METHOD, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Xin FENG, Shenzhen (CN)

(21) Appl. No.: 19/213,711

(22) Filed: May 20, 2025

Related U.S. Application Data
(63) Continuation of application No. PCT/CN2024/079888, filed on Mar. 4, 2024.

(30) Foreign Application Priority Data
Apr. 28, 2023 (CN) 202310485562.9

(51) Int. Cl. G10L 21/007; G10L 25/18; G10L 25/30

(52) U.S. Cl. CPC G10L 21/007; G10L 25/18; G10L 25/30

(57) ABSTRACT

An audio processing method is applied to an electronic device and includes obtaining target audio with a first timbre, and obtaining object audio of a target object; performing timbre feature extraction on the object audio, to obtain a timbre feature of the object audio, the timbre feature being configured for representing a second timbre of the target object that is different from the first timbre; performing audio feature extraction on the target audio, to obtain an audio feature of the target audio; and generating target audio with the second timbre based on the timbre feature and the audio feature.

### CROSS-REFERENCES TO RELATED APPLICATIONS

This application is a continuation application of PCT Patent Application No. PCT/CN2024/079888, filed on Mar. 4, 2024, which claims priority to Chinese Patent Application No. 2023104855629, filed on Apr. 28, 2023, all of which is incorporated by reference in their entirety.

### FIELD OF THE TECHNOLOGY

The present disclosure relates to the field of artificial intelligence and audio processing technologies and, in particular, to an audio processing method and apparatus, an electronic device, a computer-readable storage medium, and a computer program product.

### BACKGROUND OF THE DISCLOSURE

Timbre conversion is often achieved by editing an audio waveform through manual auditory perception. For example, by loading source audio into audio editing software, manually listening to a target timbre and a timbre of the source audio, and manually adjusting the audio waveform, the timbre of the source audio is made as close to the target timbre as possible. However, manual timbre conversion has the problems of low efficiency and serious human subjective influence, resulting in unsatisfactory efficiency and effect of audio timbre conversion.

### SUMMARY

One embodiment of the present disclosure provides an audio processing method, applied to an electronic device. The method includes obtaining target audio with a first timbre, and obtaining object audio of a target object; performing timbre feature extraction on the object audio, to obtain a timbre feature of the object audio, the timbre feature being configured for representing a second timbre of the target object that is different from the first timbre; performing audio feature extraction on the target audio, to obtain an audio feature of the target audio; and generating target audio with the second timbre based on the timbre feature and the audio feature.

Another embodiment of the present disclosure provides an electronic device. The electronic device includes one or more processors and a memory containing computer-executable instructions that, when being executed, cause the one or more processors to perform: obtaining target audio with a first timbre, and obtaining object audio of a target object; performing timbre feature extraction on the object audio, to obtain a timbre feature of the object audio, the timbre feature being configured for representing a second timbre of the target object that is different from the first timbre; performing audio feature extraction on the target audio, to obtain an audio feature of the target audio; and generating target audio with the second timbre based on the timbre feature and the audio feature.

Another embodiment of the present disclosure provides a non-transitory computer-readable storage medium containing computer-executable instructions that, when being executed, cause at least one processor to perform: obtaining target audio with a first timbre, and obtaining object audio of a target object; performing timbre feature extraction on the object audio, to obtain a timbre feature of the object audio, the timbre feature being configured for representing a second timbre of the target object that is different from the first timbre; performing audio feature extraction on the target audio, to obtain an audio feature of the target audio; and generating target audio with the second timbre based on the timbre feature and the audio feature.

### BRIEF DESCRIPTION OF THE DRAWINGS

FIG. 1 is a schematic architectural diagram of an audio processing system according to an embodiment of the present disclosure.

FIG. 2 is a schematic structural diagram of an electronic device for implementing an audio processing method according to an embodiment of the present disclosure.

FIG. 3 is a schematic flowchart of an audio processing method according to an embodiment of the present disclosure.

FIG. 4 is a schematic flowchart of an audio processing method according to an embodiment of the present disclosure.

FIG. 5 is a schematic flowchart of an audio processing method according to an embodiment of the present disclosure.

FIG. 6 is a schematic flowchart of an audio processing method according to an embodiment of the present disclosure.

FIG. 7 is a schematic flowchart of an audio processing method according to an embodiment of the present disclosure.

FIG. 8 is a schematic architectural diagram of an audio processing system according to an embodiment of the present disclosure.

FIG. 9 is a schematic flowchart of timbre feature extraction according to an embodiment of the present disclosure.

FIG. 10 is a schematic structural diagram of a timbre feature extraction layer according to an embodiment of the present disclosure.

FIG. 11 is a schematic structural diagram of a timbre feature transformation layer according to an embodiment of the present disclosure.

FIG. 12 is a schematic structural diagram of a timbre conversion model according to an embodiment of the present disclosure.

### DESCRIPTION OF EMBODIMENTS

To make objectives, technical solutions, and advantages of the present disclosure clearly, the following further describes the present disclosure in detail with reference to accompanying drawings. The described embodiments cannot be regarded as limitation of the present disclosure. All other embodiments obtained by a person skilled in the art without creative efforts shall fall within the protection scope of the present disclosure.

In the following descriptions, related “some embodiments” describe a subset of all possible embodiments. However, the “some embodiments” may be the same subset or different subsets of all the possible embodiments, and may be combined with each other without conflict.

In the following descriptions, the term “first/second/third” is merely intended to distinguish between similar objects and does not indicate a specific sequence of the objects. The “first/second/third” may be interchanged in a specific order or sequence if permitted, so that embodiments of the present disclosure described herein may be implemented in a sequence other than that illustrated or described herein.

Unless otherwise defined, meanings of all technical and scientific terms used in the embodiments of the present disclosure are the same as those usually understood by a person skilled in the art. Terms used in the embodiments of the present disclosure are merely intended to describe objectives of the embodiments of the present disclosure, but are not intended to limit the present disclosure.

The present disclosure provides an audio processing method and apparatus, an electronic device, a computer-readable storage medium, and a computer program product, which may be applied to various scenarios such as cloud technology, artificial intelligence, intelligent traffic, and assisted driving. The method includes: obtaining target audio with a first timbre, and obtaining object audio of a target object; performing timbre feature extraction on the object audio, to obtain a timbre feature of the object audio, the timbre feature being configured for representing a second timbre of the target object that is different from the first timbre; performing audio feature extraction on the target audio, to obtain an audio feature of the target audio; and generating target audio with the second timbre based on the timbre feature and the audio feature.

Before the embodiments of the present disclosure are further described in detail, a description is made on nouns and terms in the embodiments of the present disclosure, and the nouns and terms in the embodiments of the present disclosure are applied to the following explanations.

(1) Client is an application program that runs in a terminal and that is configured to provide various services, for example, a client supporting audio processing.

(2) “In response” is used to indicate a condition or a state on which a performed operation depends, and when the condition or the state on which the performed operation depends is satisfied, one or more operations may be performed in real time, or may be performed with a set delay; and there is no limit to a sequence on a plurality of performed operations unless otherwise specified.

(3) Time domain and frequency domain are two dimensional concepts measuring audio features. In the time domain, a sampling point of an audio signal is presented and processed in time, and the sampling point is correlated to the time. The audio signal may be transformed from the time domain into the frequency domain through Fourier transform. The frequency domain represents energy distribution of the audio signal in each frequency band, and includes feature representation of the audio signal to some extent.

(4) Mel frequency is a nonlinear frequency scale determined based on sensory judgment of human ears for an isometric pitch change, and is a frequency scale that can be manually set to better cater to a change of an auditory perception threshold of the human ears when audio signal processing is performed.

(5) Convolutional neural network (CNN) is a feedforward neural network, and artificial neurons of the CNN can respond to some surrounding units in coverage and have excellent performance for large image processing. The convolutional neural network includes one or more convolutional layers and a fully-connected layer (corresponding to a classic neural network) on the top, and also includes an association weight and a pooling layer.

(6) Pretrained audio neural networks (PANNS) are audio neural networks based on large audio datasets and training, re configured for audio pattern recognition or audio frame-level embedding, and is used as front-end encoding networks for a plurality of models.

(7) U-Net model is an algorithm that uses a fully convolutional network to perform semantic segmentation.

(8) Attention mechanism is a problem-solving method proposed by imitating human attention, and refers to quickly selecting valuable information from a large amount of information. It is mainly used for solving a problem of obtaining a proper vector representation when an input sequence of a sequential model is long. The approach involves retaining an intermediate result of the sequential model, applying a new model to learn the intermediate result, and associating the intermediate result with an output, to achieve information selection.

(9) Timbre refers to a distinct characteristic that different sounds exhibit in terms of their waveforms, and is the characteristic of a sound.

Artificial Intelligence (AI) is a comprehensive technology in computer science. Through the research of design principles and implementation methods of various smart machines, a machine is provided with functions of perception, inference, and decision-making. The artificial intelligence technology is a comprehensive subject, and generally includes, for example, a sensor, a dedicated artificial intelligence chip, cloud computing, distributed storage, a big data processing technology, a pre-training model technology, an operation/interaction system, and mechatronics. A pretrained model is also referred to as a large model or a basic model, and after fine adjustment, may be widely applied to downstream tasks in various large directions of the artificial intelligence. With the development of technologies, the artificial intelligence technology will be applied to more fields, and play an increasingly important role. Based on this, the embodiments of the present disclosure provide an audio processing method and apparatus, an electronic device, a computer-readable storage medium, and a computer program product, which relate to the artificial intelligence technology, and can improve the timbre conversion effect and efficiency. Descriptions are provided below respectively.

During application of the embodiments, the collection and processing of relevant data in the present disclosure needs to strictly adhere to the requirements of relevant national laws and regulations, to obtain the informed consent or separate consent from the personal information subjects, and perform subsequent data usage and processing activities within the scope authorized by the laws and regulations and the personal information subjects.

In the timbre conversion technology involved in the present disclosure, when the embodiments of the present disclosure are applied to a specific product or technology, the collection, use, and processing of timbre data (for example, object audio of a target object in the present disclosure) comply with the requirements of national laws and regulations. Prior to collecting the timbre data, information processing rules have been communicated and a separate consent from the target object has been obtained. Timbre information is processed in strict accordance with the requirements of the laws and regulations and personal information processing rules, and technical measures are taken to ensure the security of the relevant data.

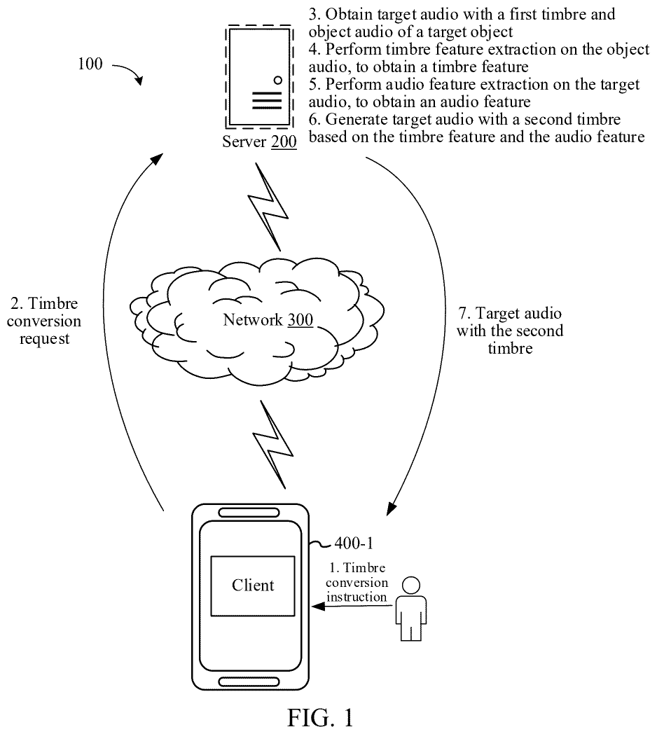

An audio processing system provided in an embodiment of the present disclosure is described below. FIG. 1 is a schematic architectural diagram of an audio processing system 100 according to an embodiment of the present disclosure. To support an exemplary application, a terminal (a terminal 400-1 is exemplarily shown) is connected to a server 200 through a network 300. The network 300 may be a wide area network, a local area network, or a combination thereof, and data transmission is implemented by using a wireless or wired link.

The terminal (for example, 400-1, which may be provided with a client supporting audio processing) is configured to transmit, in response to a timbre conversion instruction for target audio, a timbre conversion request for the target audio to the server 200. The server 200 is configured to receive the timbre conversion request transmitted by the terminal; obtain target audio with a first timbre in response to the timbre conversion request, and obtain object audio of a target object; perform timbre feature extraction on the object audio, to obtain a timbre feature of the object audio, the timbre feature being configured for representing a second timbre of the target object that is different from the first timbre; perform audio feature extraction on the target audio, to obtain an audio feature of the target audio; generate target audio with the second timbre based on the timbre feature and the audio feature; and return the target audio with the second timbre to the terminal. The terminal (for example, 400-1) is further configured to receive the target audio with the second timbre that is returned by the server 200.

In some embodiments, the audio processing method provided in the embodiments of the present disclosure may be implemented by various electronic devices, for example, may be independently implemented by a terminal, or may be independently implemented by a server, or may be cooperatively implemented by a terminal and a server. The audio processing method provided in the embodiments of the present disclosure may be applied to various scenarios, which include, but are not limited to, a cloud technology, artificial intelligence, smart transportation, assisted driving, unmanned driving, automatic driving, a game, audio and video, instant messaging, a user generated content (UGC) scenario, a virtual assistant, an intelligent customer service, an intelligent voice interaction technology, and the like.

In some embodiments, the electronic device for implementing the audio processing method provided in the embodiments of the present disclosure may be various types of terminals or servers. The server (for example, the server 200) may be an independent physical server, or may be a server cluster including a plurality of physical servers or a distributed system. The terminal (for example, the terminal 400-1) may be a notebook computer, a tablet computer, a desktop computer, a smart phone, an intelligent voice interaction device (for example, a smart speaker), an intelligent appliance (for example, a smart television), a smartwatch, an in-vehicle terminal, a wearable device, a virtual reality (VR) device, or the like, but is not limited thereto. The terminal may be provided with a client supporting audio processing, such as an audio client, a video client, a game client, an information stream client, or a browser client. The terminal and the server may be directly or indirectly connected in a wired or wireless communication mode. This is not limited in the embodiments of the present disclosure.

In some embodiments, the audio processing method provided in the embodiments of the present disclosure may be implemented by using the cloud technology. The cloud technology is a hosting technology that unifies a series of resources such as hardware, software, and networks in a wide area network or a local area network to implement computing, storage, processing, and sharing of data. The cloud technology is a collective name for a network technology, an information technology, an integration technology, a management platform technology, an application technology, and the like based on an application of a cloud computing business mode, and may form a resource pool, which is used as required, and is flexible and convenient. The cloud computing technology becomes an important support. A backend service of a technical network system requires a large quantity of computing resources and storage resources. As an example, the server (for example, the server 200) may be further a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform.

In some embodiments, a plurality of servers may be combined into a blockchain, and the server is a node on the blockchain. An information connection may exist between nodes on the blockchain, and the nodes may transmit information through the information connection. Data (for example, the target audio with the first timbre, the object audio, and the target audio with the second timbre) related to the audio processing method provided in the embodiments of the present disclosure may be stored in the blockchain.

In some embodiments, the terminal or server may implement the audio processing method provided in the embodiments of the present disclosure by running various computer-executable instructions or a computer program. For example, the computer-executable instructions may be microprogram-level commands, machine instructions, or software instructions. The computer program may be a native program or a software module in an operating system; may be a native application (APP), that is, a program that needs to be installed in the operating system for running; or may be a mini program that can be embedded into any APP, that is, a program that only needs to be downloaded into a browser environment to run. In conclusion, the computer-executable instructions may be instructions in any form, and the computer program may be an application program, a module, or a plug-in in any form.

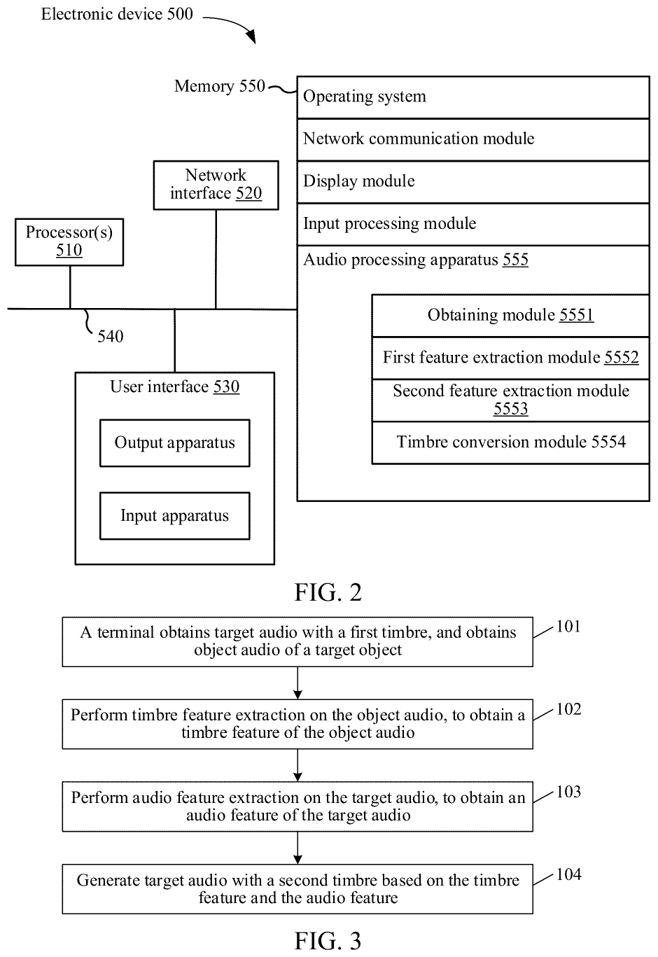

The electronic device for implementing the audio processing method according to the embodiments of the present disclosure is described below. FIG. 2 is a schematic structural diagram of an electronic device 500 for implementing an audio processing method according to an embodiment of the present disclosure. The electronic device 500 provided in this embodiment of the present disclosure may be a terminal, or a server. The electronic device 500 provided in this embodiment of the present disclosure includes: at least one processor 510, a memory 550, at least one network interface 520, and a user interface 530. All components in the electronic device 500 are coupled together by using a bus system 540. The bus system 540 is configured to implement connection and communication between the components. In addition to a data bus, the bus system 540 further includes a power bus, a control bus, and a status signal bus. However, for a clear description, all types of buses are marked as the bus system 540 in FIG. 2.

In some embodiments, the audio processing apparatus provided in the embodiments of the present disclosure may be implemented in a software mode. FIG. 2 shows an audio processing apparatus 555 stored in the memory 550. The audio processing apparatus 555 may be software in a form of a program, a plug-in, and the like, and includes the following software modules: an obtaining module 5551, a first feature extraction module 5552, a second feature extraction module 5553, and a timbre conversion module 5554. These modules are logical, and therefore may be combined in different manners or further split according to an implemented function. Functions of the modules are described below.

The audio processing method provided in the embodiments of the present disclosure is described below. In some embodiments, the audio processing method provided in the embodiments of the present disclosure may be implemented by various electronic devices, for example, may be independently implemented by a terminal, or may be independently implemented by a server, or may be cooperatively implemented by a terminal and a server. Using terminal implementation as an example, FIG. 3 is a schematic flowchart of an audio processing method according to an embodiment of the present disclosure. The audio processing method provided in this embodiment of the present disclosure includes:

Operation 101: A terminal obtains target audio with a first timbre, and obtains object audio of a target object.

The terminal may be provided with a client supporting audio processing, and to-be-processed audio is processed by running the client. In this embodiment of the present disclosure, the audio processing refers to performing timbre conversion on the audio, namely, transforming the timbre of the audio from a timbre 1 into a timbre 2, where the timbre 1 is different from the timbre 2.

In operation 101, during audio processing, to-be-processed target audio is first obtained, and the target audio is audio with the first timbre. In this embodiment of the present disclosure, the timbre of the target audio is transformed from the first timbre into a second timbre of the target object (the second timbre is different from the first timbre). Therefore, the terminal further needs to obtain the object audio of the target object. The object audio is audio obtained by using the target object as a sounding object. The target object may be a real person (such as a speaker or a singer), a virtual character (such as a game character or an anime character), a robot, or the like.

Operation 102: Perform timbre feature extraction on the object audio, to obtain a timbre feature of the object audio.

The timbre feature is configured for representing the second timbre of the target object that is different from the first timbre.

In operation 102, after the object audio of the target object is obtained, timbre feature extraction is performed on the object audio, to obtain the timbre feature of the object audio. The timbre feature is configured for representing the second timbre of the target object. That is, the timbre feature is a representation of the second timbre of the target object, and can represent a timbre characteristic of the second timbre of the target object. In addition, the timbre feature carries identification information of the target object. In other words, the timbre feature can represent that the second timbre belongs to the target object. The second timbre is different from the first timbre. Based on this, the timbre of the target audio may be subsequently transformed from the first timbre into the second timbre based on the timbre feature of the object audio.

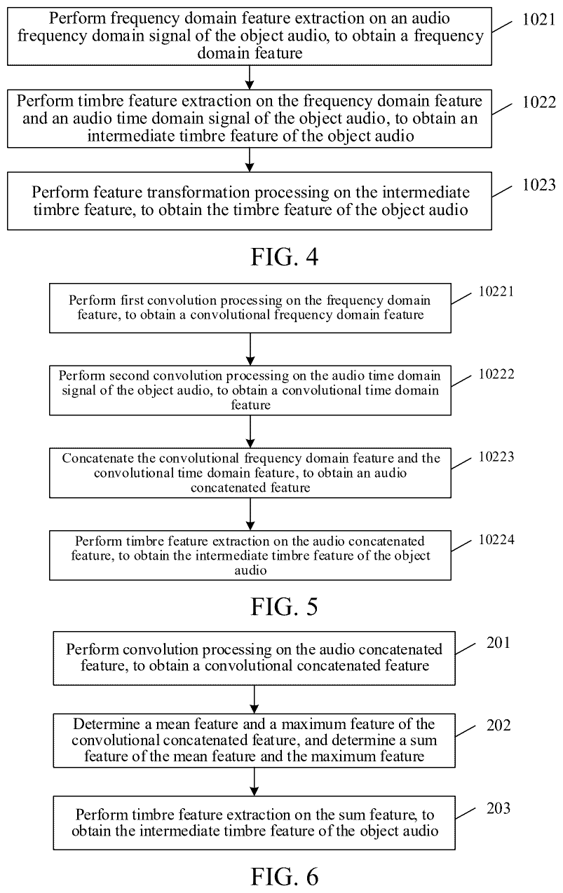

In some embodiments, FIG. 4 shows that operation 102 shown in FIG. 3 may be implemented through operations 1021 to 1023. Operation 1021: Perform frequency domain feature extraction on an audio frequency domain signal of the object audio, to obtain a frequency domain feature. Operation 1022: Perform timbre feature extraction on the frequency domain feature and an audio time domain signal of the object audio, to obtain an intermediate timbre feature of the object audio. Operation 1023: Perform feature transformation processing on the intermediate timbre feature, to obtain the timbre feature of the object audio.

The timbre feature extraction is separately processed from two aspects of the object audio, including: the audio frequency domain signal of the object audio, and the audio time domain signal of the object audio. First, in operation 1021, frequency domain feature extraction is performed on the audio frequency domain signal of the object audio, to obtain the frequency domain feature. For example, Mel spectrum feature extraction may be performed on the object audio, to obtain a Mel spectrum feature of the object audio.

Then, in operation 1022, timbre feature extraction is performed on the frequency domain feature and the audio time domain signal of the object audio, to obtain the intermediate timbre feature of the object audio. For example, the frequency domain feature and the audio time domain signal of the object audio may be concatenated, and timbre feature extraction is performed on a concatenated result, to obtain the intermediate timbre feature of the object audio. In some embodiments, the frequency domain feature of the object audio includes a plurality of frequency domain sub-features. Correspondingly, operation 1022 shown in FIG. 4 may be implemented through the following operations: performing, for each frequency domain sub-feature, timbre feature extraction on the frequency domain sub-feature and the audio time domain signal of the object audio, to obtain a timbre sub-feature; and constructing a timbre sub-feature sequence based on a plurality of timbre sub-features, and using the timbre sub-feature sequence as the intermediate timbre feature of the object audio.

The frequency domain feature includes the plurality of frequency domain sub-features. Therefore, when timbre feature extraction is performed, the following processing is separately performed on each frequency domain sub-feature: timbre feature extraction is performed on the frequency domain sub-feature and the audio time domain signal of the object audio, to obtain the timbre sub-feature of the frequency domain sub-feature, for example, the frequency domain sub-feature and the audio time domain signal of the object audio may be concatenated, and timbre feature extraction is performed on the concatenated result, to obtain the timbre sub-feature. In this way, a plurality of timbre sub-features are obtained. Therefore, based on the plurality of timbre sub-features, a time sequence including the plurality of timbre sub-features, that is, the timbre sub-feature sequence, is constructed. The timbre sub-feature sequence is the intermediate timbre feature of the object audio. In this way, the intermediate timbre feature with a sequential characteristic and a better representation capability can be obtained, thereby improving the expression capability of the timbre feature and the timbre conversion effect of performing timbre conversion based on the timbre feature.

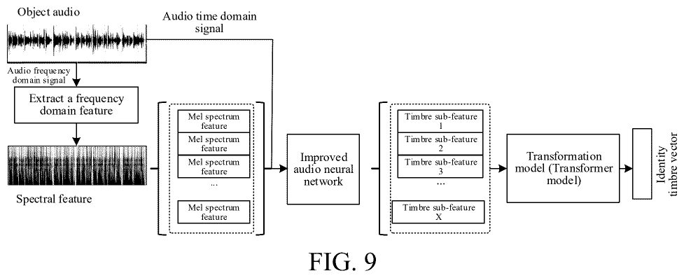

In actual application, the timbre feature extraction processing in operation 1022 may be implemented by using a timbre feature extraction layer (e.g., improved audio neural networks (PANNS) shown in FIG. 9). As shown in FIG. 9, frequency domain feature extraction is performed on the audio frequency domain signal of the object audio, to obtain the frequency domain feature. The frequency domain feature includes the plurality of frequency domain sub-features (e.g., Mel spectrum features Log-melspectrom (Log-mel)). The frequency domain feature and the audio time domain signal of the object audio are inputted into the improved PANNS, to obtain the intermediate timbre feature, and the intermediate timbre feature includes the plurality of timbre sub-features, namely, a timbre sub-feature 1 to a timbre sub-feature X (an embedding 1 to an embedding X).

Next, in operation 1023, feature transformation processing is performed on the intermediate timbre feature, to obtain the timbre feature of the object audio. In some embodiments, operation 1023 shown in FIG. 4 may be implemented through operations 10231 and 10232: Operation 10231: Encode the intermediate timbre feature, to obtain an encoded timbre feature. Operation 10232: Decode the encoded timbre feature, to obtain the timbre feature of the object audio.

Since the intermediate timbre feature is the timbre sub-feature sequence including the plurality of timbre sub-features, feature transformation processing may be implemented by using a timbre feature transformation layer (e.g., a transformation model, a conversion model, or Transformer model). In actual application, the Transformer model includes an encoding model (Encoder) and a decoding model (Decoder). The encoding model may include a plurality of (for example, 6) encoding layers, and the decoding model may also include a plurality of (for example, 6) decoding layers. The intermediate timbre feature may be encoded by using the encoding model, to obtain the encoded timbre feature, and the intermediate timbre feature may be decoded by using the decoding model, to obtain the timbre feature of the object audio. In actual application, the encoding model actually includes a self-attention processing layer (e.g., a Self-Attention layer) and a feedforward neural network. The decoding model actually includes a self-attention processing layer (e.g., a Self-Attention layer), a feedforward neural network, and an attention mechanism processing layer (e.g., an Attention layer). Still referring to FIG. 9, the timbre sub-feature sequence including the plurality of timbre sub-features (the embedding 1 to the embedding X) is inputted into the Transformer model, and feature transformation processing is performed by using the Transformer model, to output the timbre feature (e.g., an identity timbre vector shown in FIG. 9) of the object audio.

In this way, the timbre feature extraction layer (implemented by using the improved PANNS model) and the timbre feature transformation layer (implemented by using the Transformer model) jointly form a timbre feature extraction model. Based on this, operation 102 may be implemented by using the timbre feature extraction model.

In some embodiments, FIG. 5 shows that operation 1022 shown in FIG. 4 may be implemented through operations 10221 to 10224: Operation 10221: Perform first convolution processing on the frequency domain feature, to obtain a convolutional frequency domain feature. Operation 10222: Perform second convolution processing on the audio time domain signal of the object audio, to obtain a convolutional time domain feature. Operation 10223: Concatenate the convolutional frequency domain feature and the convolutional time domain feature, to obtain an audio concatenated feature. Operation 10224: Perform timbre feature extraction on the audio concatenated feature, to obtain the intermediate timbre feature of the object audio.

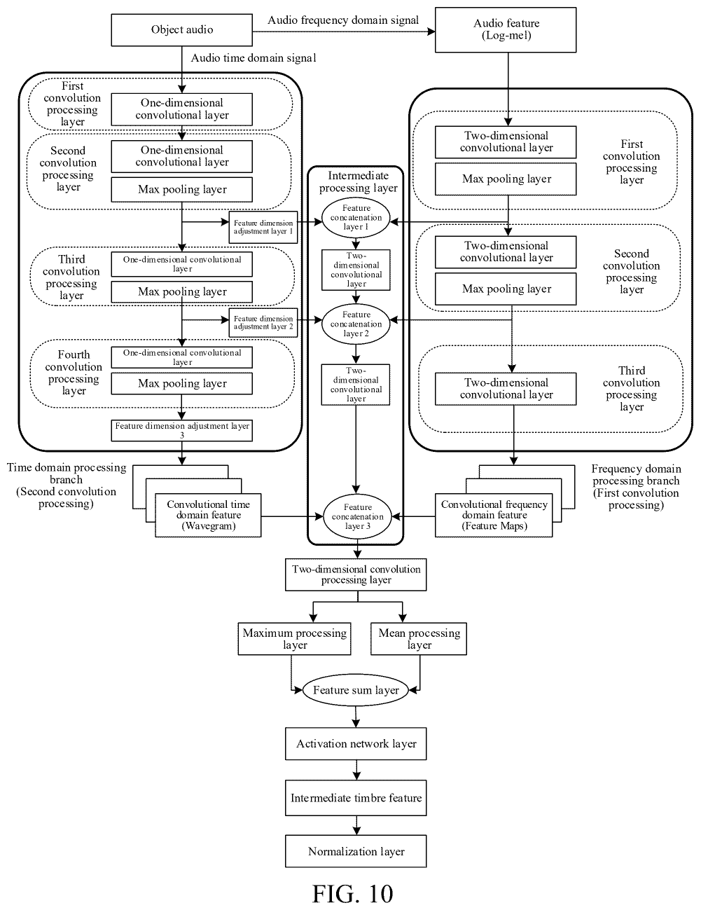

In a process of performing timbre feature extraction in operation 1022, first, in operation 10221, first convolution processing is performed on the frequency domain feature, to obtain the convolutional frequency domain feature. The first convolution processing may include a plurality of layers of convolution processing, each layer of convolution processing is implemented by using a corresponding convolutional layer, and the convolutional layer may be a two-dimensional convolutional layer. In this way, the frequency domain feature of the audio can be learned to obtain a frequency domain feature of the object audio. As an example, referring to FIG. 10, first convolution processing is performed on the audio feature (the Mel spectrum feature Log-Mel) by using a first convolution processing layer, to obtain convolutional frequency domain features (e.g., Feature Maps). The first convolution processing includes three convolution processing layers, where the first convolution processing layer and the second convolution processing layer respectively include a two-dimensional convolutional layer (Conv2D Block) and a max pooling layer (MaxPooling2D); and the third convolution processing layer includes a two-dimensional convolutional layer (Conv2D Block).

In operation 10222, second convolution processing is performed on the audio time domain signal of the object audio, to obtain the convolutional time domain feature. The second convolution processing may include a plurality of layers of convolution processing, each layer of convolution processing is implemented by using a corresponding convolutional layer, and the convolutional layer may be a one-dimensional convolutional layer. In this way, the time domain feature of the audio can be learned to obtain a time domain feature of the object audio. As an example, referring to FIG. 10, second convolution processing is performed on the audio time domain signal by using the second convolution processing layer, to obtain a convolutional time domain feature (e.g., Wavegram). The second convolution processing includes four convolution processing layers, where the first convolution processing layer is a one-dimensional convolutional layer (Conv1D), and the second, third, and fourth convolution processing layers respectively include a one-dimensional convolutional layer (Conv1D Block) and a max pooling layer (MaxPooling1D, s (e.g., stride)=4)

In operation 10223, the convolutional frequency domain feature and the convolutional time domain feature may further be concatenated, to obtain the audio concatenated feature, thereby achieving feature complementarity between the time domain feature and the frequency domain feature, improving the timbre feature extraction effect, and further improving the timbre conversion effect of performing timbre conversion based on the timbre feature. As an example, referring to FIG. 10, the convolutional frequency domain feature and the convolutional time domain feature are concatenated by using a feature concatenation layer 3 (e.g., concat3). In operation 10224, timbre feature extraction is performed on the audio concatenated feature, to obtain the intermediate timbre feature of the object audio.

During actual implementation, in operation 10223, when the convolutional frequency domain feature and the convolutional time domain feature are concatenated, if feature dimensions of the convolutional frequency domain feature and the convolutional time domain feature are inconsistent, feature dimension adjustment processing may further be performed on the convolutional time domain feature, to obtain a convolutional time domain feature with the same feature dimension as the convolutional frequency domain feature, thereby concatenating the convolutional frequency domain feature and the convolutional time domain feature. As an example, referring to FIG. 10, feature dimension adjustment processing is performed on the convolutional time domain feature by using a feature dimension adjustment layer 3 (Reshape3), to obtain the convolutional time domain feature with the same feature dimension as the convolutional frequency domain feature. In this way, feature dimensions are unified, thereby implementing feature concatenation of the convolutional frequency domain feature and the convolutional time domain feature. Therefore, the intermediate timbre feature can represent both the time domain feature of the object audio and the frequency domain feature of the object audio, thereby improving the timbre feature extraction effect.

In some embodiments, the first convolution processing includes M layers of convolution processing, and the second convolution processing includes N layers of convolution processing. Correspondingly, before performing operation 10223, the terminal further performs the following processing: obtaining an intermediate convolutional frequency domain feature obtained by an m^{th} layer of convolution processing in the first convolution processing, and obtaining an intermediate convolutional time domain feature obtained by an nth layer of convolution processing in the second convolution processing; and concatenating the intermediate convolutional frequency domain feature and the intermediate convolutional time domain feature to obtain an intermediate audio concatenated feature. Correspondingly, operation 10223 shown in FIG. 5 may be implemented through the following operation: concatenating the convolutional frequency domain feature, the convolutional time domain feature, and the intermediate audio concatenated feature, to obtain the audio concatenated feature, where M, N, m, and n are integers greater than 1, m is less than M, and n is less than N.

Since the first convolution processing includes the M layers of convolution processing, and the second convolution processing includes the N layers of convolution processing, during convolution processing, convolutional features outputted by intermediate layers of convolution processing may further be concatenated, to implement a plurality of information exchanges in the convolution process of the time domain feature and the frequency domain feature of the object audio, and make the time domain feature and the frequency domain feature maintain complementary information, thereby improving the representation capability of a finally obtained audio feature for the object audio, and further improving the timbre conversion effect of performing timbre conversion based on the timbre feature.

In other words, the intermediate convolutional frequency domain feature obtained by the m^{th} layer of convolution processing in the first convolution processing is obtained, the intermediate convolutional time domain feature obtained by the nth layer of convolution processing in the second convolution processing is obtained, and then the intermediate convolutional frequency domain feature and the intermediate convolutional time domain feature are concatenated, to obtain the intermediate audio concatenated feature. There may be a plurality of values of m and n, for example, m may be values of 1, 2, and 3, so that intermediate convolutional frequency domain features respectively obtained through the first, second, and third layers of convolution processing in the first convolution processing are obtained. For example, if n may be values of 1 and 2, the intermediate convolutional time domain features respectively obtained through the first and second layers of convolution processing in the second convolution processing are obtained. If the intermediate convolutional frequency domain features and the intermediate convolutional time domain features of the plurality of layers of convolution processing are obtained, the following processing may be performed according to an order of the layers of the convolution processing: For example, when an intermediate convolutional frequency domain feature obtained by the first layer of convolution processing and an intermediate convolutional time domain feature obtained by the first layer of convolution processing are obtained, the intermediate convolutional frequency domain feature and the intermediate convolutional time domain feature obtained by the first layer of convolution processing may be concatenated, to obtain the first layer of intermediate audio concatenated feature; and when an intermediate convolutional frequency domain feature obtained by the second layer of convolution processing and an intermediate convolutional time domain feature obtained by the second layer of convolution processing are obtained, the intermediate convolutional frequency domain feature and the intermediate convolutional time domain feature that are obtained by the second layer of convolution processing and the first layer of intermediate audio concatenated feature may be concatenated to obtain the second layer of intermediate audio concatenated feature, and so on. When an intermediate convolutional frequency domain feature obtained by an x^{th} layer of convolution processing (where x is an integer not greater than M and N) and an intermediate convolutional time domain feature obtained by the x^{th} layer of convolution processing are obtained, the intermediate convolutional frequency domain feature and the intermediate convolutional time domain feature that are obtained by the x^{th} layer of convolution processing and an (x−1)^{th} layer of intermediate audio concatenated feature may be concatenated, to obtain an x^{th} layer of intermediate audio concatenated feature. Certainly, convolution processing may further be performed on the (x−1)^{th} layer of intermediate audio concatenated feature. In this way, the (x−1)^{th} layer of intermediate audio concatenated feature obtained after the convolution processing is concatenated with the intermediate convolutional frequency domain feature and the intermediate convolutional time domain feature that are obtained by the x^{th} layer of convolution processing. In this way, information exchange between the time domain feature and the frequency domain feature during each layer of convolution processing is implemented, so that the time domain feature and the frequency domain feature fully complement each other during the processing, thereby improving the representation capability of the finally obtained audio feature for the object audio, and further improving the timbre conversion effect of performing timbre conversion based on the timbre feature.

In this way, in operation 10223, the convolutional frequency domain feature, the convolutional time domain feature, and the intermediate audio concatenated feature may be concatenated to obtain the audio concatenated feature.

Referring to FIG. 10, an intermediate convolutional time domain feature (which may be obtained after processing of a feature dimension adjustment layer 1 (Reshape1)) of the second layer of convolution processing (the second convolution processing layer) in the second convolution processing and an intermediate convolutional frequency domain feature of the first layer of convolution processing (the first convolution processing layer) in the first convolution processing are concatenated by using a feature concatenation layer 1 (concat1), to obtain the first layer of intermediate audio concatenated feature; convolution processing is performed on the first layer of intermediate audio concatenated feature by using a two-dimensional convolutional layer (conv2D Block), to obtain the first layer of convolutional concatenated feature; an intermediate convolutional time domain feature (which may be obtained after processing of a feature dimension adjustment layer 2 (Reshape2)) of the third layer of convolution processing (the third convolution processing layer) in the second convolution processing and an intermediate convolutional frequency domain feature of the second layer of convolution processing (the second convolution processing layer) in the first convolution processing are concatenated by using a feature concatenation layer 2 (concat2), to obtain the second layer of intermediate audio concatenated feature; convolution processing is performed on the second layer of intermediate audio concatenated feature by using a two-dimensional convolutional layer (conv2D Block), to obtain the second layer of convolutional concatenated feature; and finally, the second layer of convolutional concatenated feature, the convolutional frequency domain feature, and the convolutional time domain feature are concatenated by using a feature concatenation layer 3 (concat3), to obtain an audio concatenated feature.

In some embodiments, FIG. 6 shows that operation 10224 shown in FIG. 5 may be implemented through operation 201 to operation 203: Operation 201: Perform convolution processing on the audio concatenated feature, to obtain a convolutional concatenated feature. Operation 202: Determine a mean feature and a maximum feature of the convolutional concatenated feature, and determine a sum feature of the mean feature and the maximum feature. Operation 203: Perform timbre feature extraction on the sum feature, to obtain the intermediate timbre feature of the object audio.

After the audio concatenated feature is obtained, first, in operation 201, convolution processing is performed on the audio concatenated feature, to obtain the convolutional concatenated feature. The convolution processing may be two-dimensional convolution processing. In operation 202, mean processing and maximum calculation processing are separately performed on the convolutional concatenated feature, to obtain the mean feature and the maximum feature of the convolutional concatenated feature; then, the mean feature and the maximum feature are added, to obtain the sum feature of the mean feature and the maximum feature; and then, in operation 203, timbre feature extraction is performed on the sum feature, to obtain the intermediate timbre feature of the object audio. During actual implementation, timbre feature extraction may be performed on the sum feature by using an activation network layer including an activation function (for example, a rectified function (Relu function)), to obtain the intermediate timbre feature of the object audio.

As an example, referring to FIG. 10, operation 10224 is implemented by using a timbre extraction layer. The timbre extraction layer includes a two-dimensional convolution processing layer (2D CNN layer) and is configured for performing convolution processing on the audio concatenated feature, to obtain the convolutional concatenated feature. The timbre extraction layer includes a mean processing layer (a mean layer) and a maximum processing layer (a max layer). The mean processing layer (the mean layer) is configured for performing mean processing on the convolutional concatenated feature, to obtain the mean feature. The maximum processing layer (the max layer) is configured for performing maximum calculation processing on the convolutional concatenated feature, to obtain the maximum feature. The timbre extraction layer includes a feature sum layer (a sum layer) and is configured for adding the mean feature and the maximum feature to obtain the sum feature. The timbre extraction layer includes the activation network layer (e.g., a Relu layer) and is configured for performing timbre feature extraction on the sum feature, to obtain the intermediate timbre feature (vector) of the object audio. The timbre extraction layer may further include a normalization layer (e.g., a softmax layer) and is configured for normalizing the intermediate timbre feature, to obtain a normalized timbre feature.

Operation 103: Perform audio feature extraction on the target audio, to obtain an audio feature of the target audio.

In operation 103, audio feature extraction is further performed on the target audio, to obtain the audio feature of the target audio. In some embodiments, the terminal may perform audio feature extraction on the target audio in the following manners, to obtain the audio feature of the target audio: obtaining an audio frequency domain signal of the target audio; and performing frequency domain feature extraction on the audio frequency domain signal of the target audio, to obtain the audio feature of the target audio. That is, the audio feature is a frequency domain feature of the target audio, for example, a Mel spectrum feature. In actual application, the audio feature may be a Mel spectrum feature map of the target audio.

In some embodiments, the terminal may further perform audio feature extraction on the target audio in the following manners, to obtain the audio feature of the target audio: obtaining an audio time domain signal of the target audio; and performing time domain feature extraction on the audio time domain signal of the target audio, to obtain the audio feature of the target audio.

In some embodiments, the terminal may alternatively perform audio feature extraction on the target audio in the following manners, to obtain the audio feature of the target audio: performing frequency domain feature extraction on an audio frequency domain signal of the target audio, to obtain an audio frequency domain feature of the target audio; performing time domain feature extraction on an audio time domain signal of the target audio, to obtain an audio time domain feature of the target audio; and concatenating the audio frequency domain feature of the target audio and the audio time domain feature of the target audio, to obtain the audio feature of the target audio.

In this way, the audio feature of the target audio is extracted in a plurality of manners, and may be set according to requirements. This can improve the capability of extracting the audio feature of the target audio, to obtain a more required audio feature of the target audio, thereby improving the timbre conversion effect of performing timbre conversion based on the audio feature.

Operation 104: Generate target audio with a second timbre based on the timbre feature and the audio feature.

In operation 104, after the timbre feature of the object audio and the audio feature of the target audio are obtained, the target audio with the second timbre may be generated based on the timbre feature and the audio feature, to implement timbre conversion on the target audio, that is, the timbre of the target audio is transformed from the first timbre into the second timbre. In some embodiments, the terminal may generate the target audio with the second timbre based on the timbre feature and the audio feature in the following manners: concatenating the timbre feature and the audio feature, to obtain a first concatenated feature, and performing convolution processing on the first concatenated feature, to obtain a convolutional feature; and concatenating the convolutional feature and the timbre feature, to obtain a second concatenated feature, and performing upsampling processing on the second concatenated feature, to obtain the target audio with the second timbre. In this way, the timbre feature is added to each processing step, so that the timbre of the generated target audio is closer to the second timbre, thereby improving the timbre conversion effect.

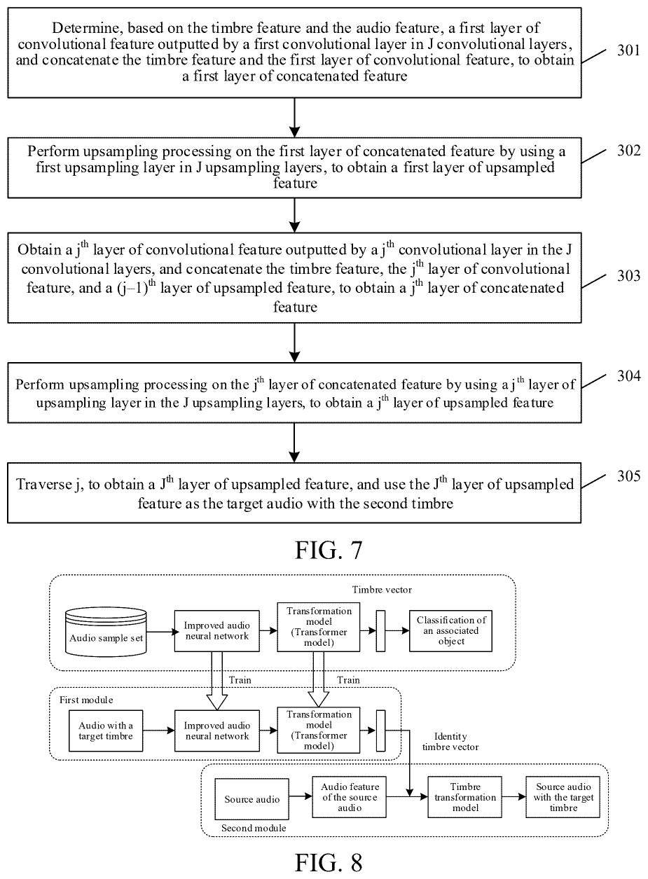

In some embodiments, based on the timbre feature and the audio feature, the terminal may generate the target audio with the second timbre by using a timbre conversion model. The timbre conversion model includes J convolutional layers and J upsampling layers. Based on this, FIG. 7 shows that the operation of generating target audio with the second timbre by using a timbre conversion model includes:

Operation 301: Determine, based on the timbre feature and the audio feature, a first layer of convolutional feature outputted by a first convolutional layer in J convolutional layers, and concatenate the timbre feature and the first layer of convolutional feature, to obtain a first layer of concatenated feature. Operation 302: Perform upsampling processing on the first layer of concatenated feature by using a first upsampling layer in J upsampling layers, to obtain a first layer of upsampled feature. Operation 303: Obtain a j^{th} layer of convolutional feature outputted by a j^{th} layer of convolutional layer in the J convolutional layers, and concatenate the timbre feature, the j^{th} layer of convolutional feature, and a (j−1)^{th} layer of upsampled feature, to obtain a j^{th} layer of concatenated feature. Operation 304: Perform upsampling processing on the j^{th} layer of concatenated feature by using a j^{th} upsampling layer in the J upsampling layers, to obtain a j^{th} layer of upsampled feature. Operation 305: Traverse j, to obtain a J^{th} layer of upsampled feature, and use the J^{th} layer of upsampled feature as the target audio with the second timbre. J and j are integers greater than 1, and j is less than or equal to J.

Each convolutional layer and each upsampling layer are in a one-to-one correspondence, that is, the first convolutional layer corresponds to the first upsampling layer, the second layer of convolutional layer corresponds to the second layer upsampling layer, and the j^{th} layer of convolutional layer corresponds to the j^{th} upsampling layer. In operation 301, based on the timbre feature and the audio feature, the first layer of convolutional feature outputted by the first convolutional layer in the J convolutional layers is first determined. In some embodiments, based on the timbre feature and the audio feature, the terminal may determine the first layer of convolutional feature outputted by the first convolutional layer in the J convolutional layers in the following manners: concatenating the timbre feature and the audio feature, to obtain a J^{th} layer of concatenated feature, and performing convolution processing on the J^{th} layer of concatenated feature by using a J^{th} layer of convolutional layer in the J convolutional layers, to obtain a J^{th} layer of convolutional feature; concatenating the timbre feature and a (j+1)^{th} layer of convolutional feature, to obtain a j^{th} layer of concatenated feature, and performing convolution processing on the j^{th} layer of concatenated feature by using a j^{th} layer of convolutional layer in the J convolutional layers, to obtain a j^{th} layer of convolutional feature; and traversing j, to obtain the first layer of convolutional feature outputted by the first convolutional layer in the J convolutional layers. In this way, the timbre feature of the object audio is added to each convolutional layer, so that the timbre feature can be fully integrated into the audio feature of the target audio, thereby improving the timbre conversion effect.

Next, in operation 301, the timbre feature and the first layer of convolutional feature are further concatenated, to obtain the first layer of concatenated feature. In this way, in operation 302, upsampling processing is performed on the first layer of concatenated feature by using the first upsampling layer in the J upsampling layers, to obtain the first layer of upsampled feature. In operation 303, the j^{th} layer of convolutional feature outputted by the j^{th} layer of convolutional layer in the J convolutional layers is obtained, and the timbre feature, the j^{th} layer of convolutional feature, and the (j−1)^{th} layer of upsampled feature are concatenated, to obtain the j^{th} layer of concatenated feature. Then, in operation 304, upsampling processing is performed on the j^{th} layer of concatenated feature by using the j^{th} upsampling layer in the J upsampling layers, to obtain the j^{th} layer of upsampled feature. In this way, by traversing J in operation 305, the j^{th} layer of upsampled feature can be obtained, where the j^{th} layer of upsampled feature is the target audio with the second timbre.

In actual application, the timbre conversion model may be constructed by using a U-Net network. However, during processing, the timbre feature of the object audio needs to be embedded into each layer of the U-Net network, so that the timbre feature is fully integrated into the audio feature of the target audio, and the timbre extraction model can fully learn the extracted timbre feature of the object audio, thereby improving the timbre conversion effect of performing timbre conversion based on the timbre feature.

In some examples, this embodiment of the present disclosure may be applied to a UCG scenario. For example, on an Internet platform, when a user creates and provides original content (such as audio and a video), timbre conversion may be performed on the audio made by the user by using the audio processing method provided in this embodiment of the present disclosure. Specifically, for created target audio (such as a song or a video commentary) with a first timbre (such as a user timbre), object audio of a target object (such as an anime character or a singer preferred by a user) may be obtained; timbre feature extraction is performed on the object audio, to obtain a timbre feature of the object audio, the timbre feature being configured for representing a second timbre of the target object that is different from the first timbre; audio feature extraction is performed on the target audio, to obtain an audio feature of the target audio; and target audio with the second timbre is generated based on the timbre feature and the audio feature. In this way, the target audio with the second timbre of the target object is obtained, so that the creation efficiency and effect of UCG can be improved, thereby improving the content quality of UCG on the Internet platform and increasing the user stickiness for the Internet platform.

In some examples, this embodiment of the present disclosure may be applied to the Internet of Vehicles and a map scenario. For example, for route navigation broadcast in the Internet of Vehicles and the map scenario, object audio of a target object (such as an anime character, a star or a character preferred by a user, or a user) may be obtained for target audio (such as route navigation audio) with a first timbre (such as a preset AI male timbre or AI female timbre) involved in the scenario; timbre feature extraction is performed on the object audio, to obtain a timbre feature of the object audio, the timbre feature being configured for representing a second timbre of the target object that is different from the first timbre; audio feature extraction is performed on the target audio, to obtain an audio feature of the target audio; and target audio with the second timbre is generated based on the timbre feature and the audio feature. In this way, the target audio with the second timbre of the target object is obtained, so that the attractiveness and fun of the route navigation broadcast in the Internet of Vehicles and the map scenario for the user can be improved.

In some examples, this embodiment of the present disclosure may be applied to an intelligent voice interaction scenario. For example, for target audio (such as intelligent voice interaction audio) with a first timbre (such as a preset AI male timbre or AI female timbre) involved in the intelligent voice interaction scenario (such as intelligent voice interaction of a smart speaker, intelligent voice interaction of a smartphone, or intelligent voice interaction of a smart household), object audio of a target object (such as an anime character, a star or character preferred by a user, or a user) is obtained; timbre feature extraction is performed on the object audio, to obtain a timbre feature of the object audio, the timbre feature being configured for representing a second timbre of the target object that is different from the first timbre; audio feature extraction is performed on the target audio, to obtain an audio feature of the target audio; and target audio with the second timbre is generated based on the timbre feature and the audio feature. In this way, the target audio with the second timbre of the target object is obtained, so that the interaction effect of the intelligent voice interaction scenario can be improved, and the user stickiness for intelligent voice interaction and user experience can be improved.

By applying the foregoing embodiments of the present disclosure, timbre feature extraction is first performed on object audio of a target object, to obtain a timbre feature of the object audio, the timbre feature being configured for representing a second timbre of the target object; and timbre feature extraction is then performed on target audio with a first timbre, to obtain an audio feature of the target audio. Therefore, target audio with the second timbre can be generated based on the timbre feature and the audio feature, thereby transforming the timbre of the target audio from the first timbre into the second timbre. In this way, (1) the target audio can be automatically transformed from the first timbre into the second timbre of the target object according to the timbre feature of the object audio of the target object, thereby improving the audio timbre conversion efficiency; and (2) the transformation of the target audio from the first timbre into the second timbre is implemented according to the timbre feature of the object audio of the target object, thereby avoiding the impact of manual adjustment on timbre conversion, and making the transformed timbre of the target audio closer to the second timbre of the target object, thereby improving the timbre conversion effect.

The following describes an exemplary application of this embodiment of the present disclosure in an actual application scenario. In the related art, usually, timbre conversion is achieved by editing audio through manual auditory perception. For example, in audio editing software, by artificially listening to a target timbre and a timbre of source audio, loading the source audio into the audio editing software, and then manually adjusting an audio waveform, the timbre of the source audio is made as close to the target timbre as possible. Consequently, the timbre conversion efficiency and accuracy are not high.

Based on this, an embodiment of the present disclosure provides the following audio processing method: (1) Use a Gaussian mixture model to model a timbre, and perform adaptive timbre adjustment on overall voice according to a model difference between a target timbre and a source timbre, to perform timbre conversion. However, modelling the timbre requires a large amount of audio data of the target timbre and audio data of the source timbre, which has an extremely high requirement on a data volume. (2) Train a model based on large- scale target timbre data, to obtain a model exclusive to the target timbre. However, the required data volume is also extremely large, and the model can only implement transformation of the target timbre and cannot be generalized. As a result, timbre conversion still needs a large amount of time, the timbre conversion efficiency is low, and timbre conversion cannot be performed in real time.

Based on this, an embodiment of the present disclosure further provides an audio processing method, to solve at least the foregoing existing problem. In this embodiment of the present disclosure, an audio timbre conversion method based on an identity timbre vector (e.g., the foregoing timbre feature, configured for representing the timbre feature of the target object and carrying identification information) of the target object is provided. In actual application, identity timbre vector extraction is performed on an object audio of the target object, and an extracted identity timbre vector is embedded into source audio (e.g., the foregoing target audio), to be transferred as an identity timbre in a timbre conversion process.

In this way, in this embodiment of the present disclosure, a timbre conversion model does not need to be trained by using large-scale audio data of the target timbre (e.g., a timbre of the target object, equivalent to the foregoing second timbre). An identity recognition model is directly pretrained by using audio data of a plurality of sample objects, and is used as an identity timbre vector extractor. The identity timbre vector may be directly extracted for short-duration (an audio duration is not greater than a preset duration threshold) audio by using the identity recognition model. Then, the identity timbre vector is inputted into a plurality of layers of the timbre conversion model (e.g., the improved U-Net), to perform timbre conversion on source audio, to generate the source audio with the target timbre. This achieves rapid and efficient timbre conversion without requiring large-scale timbre data of the target timbre for real-time model adjustment and training, and the identity timbre vector can be embedded into the plurality of layers of the timbre conversion model, thereby achieving a more accurate timbre conversion effect.

In actual application, this embodiment of the present disclosure may be used to perform transformation on a specified timbre of existing source audio. That is, on the premise that short-duration object audio with the target timbre is obtained, a timbre of long-duration source audio (an audio duration is greater than the preset duration threshold) can be quickly and accurately transformed into a target timbre of a sounding object of the object audio, thereby implementing timbre conversion. In this way, this embodiment of the present disclosure may be applied to the following application scenarios:

(1) In a post-production dubbing process of film and television production, according to this embodiment of the present disclosure, timbre conversion can be performed on to-be-dubbed content according to audio of a small quantity of target actors, thereby greatly facilitating post-production dubbing work of film and television production.

(2) In a function of character dubbing in a short video creator platform, according to this embodiment of the present disclosure, a timbre conversion capability can be provided for a user of the short video creator platform, to assist in dubbing without requiring the user to upload a large amount of audio with the user's own timbre, thereby improving user experience.

(3) In a singing and cover song platform, according to this embodiment of the present disclosure, a timbre of original singing audio can be transformed, according to a timbre uploaded by a user, into the user's own timbre, which satisfies the requirement of retaining the original singing effect while replacing the timbre with the user's own timbre.

FIG. 8 is a schematic architectural diagram of an audio processing system according to an embodiment of the present disclosure. In this embodiment of the present disclosure, the audio processing system provided in this embodiment of the present disclosure includes: a first module and a second module. The first module is an object identity recognition system trained based on open-source data, and the second module is an improved timbre conversion system in which an identity timbre vector is embedded.

(1) The first module is constructed by using an improved PANNS network and a Transformer network. The system is learned by using an open-source object audio sample set, so that each piece of inputted audio can be bound with an accurate object identity. After training, the system can fully learn timbre features of persons with different identities, and can be used as an identity timbre vector extractor to extract a timbre of a target unknown identity. In a practical inference stage, after receiving audio with the target timbre (e.g., the object audio of the target object), the first module can extract an identity timbre vector representing the timbre of the target object, and use the identity timbre vector as an identity timbre feature of the target timbre and input the identity timbre feature to the second module.

(2) After extracting the identity timbre vector of the target timbre, the first module inputs the identity timbre vector into a timbre conversion model (e.g., the improved U-Net) in the second module. That is, the identity timbre vector is inputted to each network layer of the improved U-Net network at the same time, so that when timbre conversion is performed, a feature network at each network layer can sense information about the target timbre. In addition, the audio feature (for example, a spectrum map of the source audio is used as the audio feature) of the source audio is inputted into the timbre conversion model, and after calculation is performed by each network layer of the improved U-Net network, the source audio with the target timbre after timbre conversion is generated.

Next, the first module is first described in detail. Referring to FIG. 9, frequency domain feature extraction is first performed on inputted object audio, to obtain a Log-mel sequence (e.g., the foregoing frequency domain feature). Then, the Log-mel sequence is inputted into an improved PANNS model, to obtain a timbre feature sequence (also referred to as a timbre sub-feature sequence, that is, the foregoing intermediate timbre feature, including a plurality of timbre sub-features (e.g., embeddings)), and the timbre feature sequence is inputted into the Transformer model, to obtain a timbre feature (e.g., the identity timbre vector) of the entire object audio. In a training stage, the first module inputs the identity timbre vector to a speaker classification module, and performs calculation training according to a classification result and a real object label. In an inference stage, the first module transmits the identity timbre vector extracted by the first module to the second module as an exclusive identity timbre symbol of the timbre of the target object.

(1) Next, the improved PANNS are described. Referring to FIG. 10, the timbre feature extraction layer is implemented by using the improved PANNS model.

(1.1) It can be learned from FIG. 10 that, inputs of the improved PANNS are an audio time domain signal of the object audio and a frequency domain feature (e.g., Log-mel) of an audio frequency domain signal of the object audio. Processing of the improved PANNS is divided into two branches, including: a frequency domain processing branch (e.g., the foregoing first convolution processing) for the frequency domain feature (e.g., Log-mel); and a time domain processing branch (e.g., the foregoing second convolution processing) for the audio time domain signal.

(1.2) A plurality of one-dimensional convolutional layers (Conv1D Blocks) are used in the time domain processing branch, so that the time domain feature of the object audio, especially information such as audio loudness and sampling point amplitude, can be directly learned. After passing through the plurality of one-dimensional convolutional layers, a generated one-dimensional time domain feature is adjusted to a two-dimensional feature map wavegram (e.g., the foregoing convolutional time domain feature) by using a Reshape3 layer, to combine outputs of the time domain processing branch and the frequency domain processing branch.

(1.3) A frequency domain spectrum (e.g., the foregoing frequency domain feature), that is, a log-mel spectrum, of the object audio is inputted to the frequency domain processing branch. The log-mel spectrum uses a Mel frequency. The frequency domain spectrum is inputted to a plurality of two-dimensional convolutional layers (Conv2D Blocks), and feature maps of a same dimension obtained by the time domain processing branch, that is, the foregoing convolutional frequency domain features, are outputted.

(1.4) An intermediate processing layer exists between the time domain processing branch and the frequency domain processing branch. A plurality of information exchanges between the two domains exist in the intermediate processing layer: a convolutional feature of the time domain processing branch is reshaped, and then is concatenated with a convolutional feature of the frequency domain processing branch, and then the convolutional feature of the time domain processing branch and the convolutional feature of the frequency domain processing branch are inputted to concat of a highest layer together. The mechanism is to enable the time domain and the frequency domain to maintain complementary information during processing, and further enable a high-layer network to perceive information about an underlying network.

(1.5) The feature maps (including the convolutional frequency domain feature and the convolutional time domain feature) that are respectively outputted by the time domain processing branch and the frequency domain processing branch and that are of the same dimension are concatenated with a feature map (e.g., the foregoing intermediate concatenated audio feature) outputted by two intermediate branches, to obtain a set of two-dimensional frequency domain feature maps (e.g., the foregoing concatenated audio feature). Then, the two-dimensional frequency domain feature maps are inputted to a two-dimensional convolutional network model (e.g., 2D CNN layer), to obtain a convolutional concatenated feature. Then a mean value (mean) and a maximum value (max) are calculated for the convolutional concatenated feature, and the obtained mean value and maximum value are added by using a sum layer, to obtain a sum feature. Finally, a timbre feature sequence is generated by using a Relu network layer.

The object audio is framed and separately inputted to the improved PANNS, and a multi-band timbre feature sequence representing the object audio can be obtained through calculation by using the improved PANNS. Since the improved PANNS only calculate a short-term correlation during calculation, that is, the timbre feature is calculated in segments, and does not include long-term association information, a timbre feature sequence obtained by the improved PANNS needs to be inputted to a next node, namely, the Transformer model, to obtain a timbre feature integrating both short-term and long-term correlations.

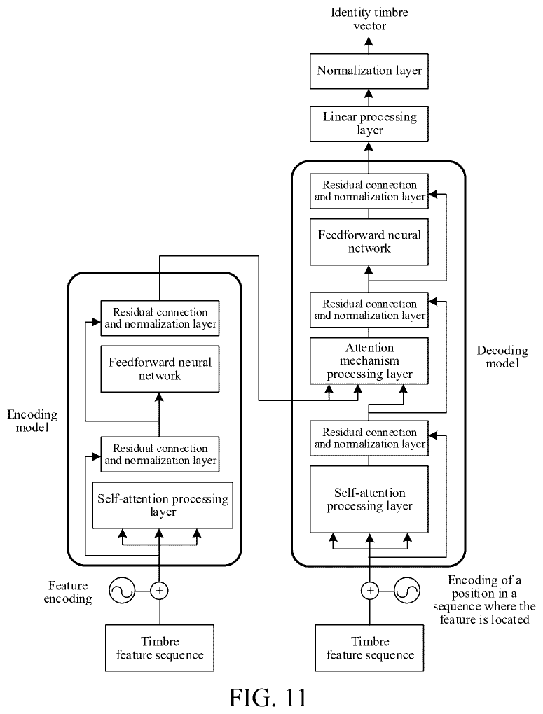

(2) Next, the Transformer model is described. Referring to FIG. 11, the timbre feature transformation layer is implemented by using the Transformer model. An encoder-decoder architecture is used in the Transformer model. In the Transformer model, an encoding model (Encoder) is stacked by six encoder layers, and a decoding model (Decoder) is stacked by six decoder layers. Each Encoder layer includes two layers: a self-attention processing layer (Multi-Head Attention) and a feedforward neural network (Feed Forward). In addition, the Encoder model further includes a residual connection and normalization layer (Add & Norm) corresponding to the self-attention processing layer, and a residual connection and normalization layer (Add & Norm) corresponding to the feedforward neural network. The self-attention processing layer can help obtain a context feature of a current processing feature. Each Decoder layer includes a self-attention processing layer (Masked Multi-Head Attention), an attention mechanism processing layer (Attention), a feedforward neural network (Feed Forward), and a residual connection and normalization layer (Add & Norm) corresponding to each layer. In addition, after an output of the Decoder model, the Transformer model further includes a linear processing layer (Linear layer) and a normalization layer (softmax layer), and finally outputs an identity timbre vector.

An input of the Transformer model is the timbre feature sequence outputted by the improved PANNS. A timbre feature (e.g., the identity timbre vector embedding) representing the object audio can be calculated by using the Transformer model. The timbre feature is inputted to the improved U-Net of the second module, so that timbre conversion can be performed on the target audio inputted to the U-Net. In actual application, there may be a plurality of identity timbre vectors embeddings, thereby improving representation richness of the identity timbre vector.

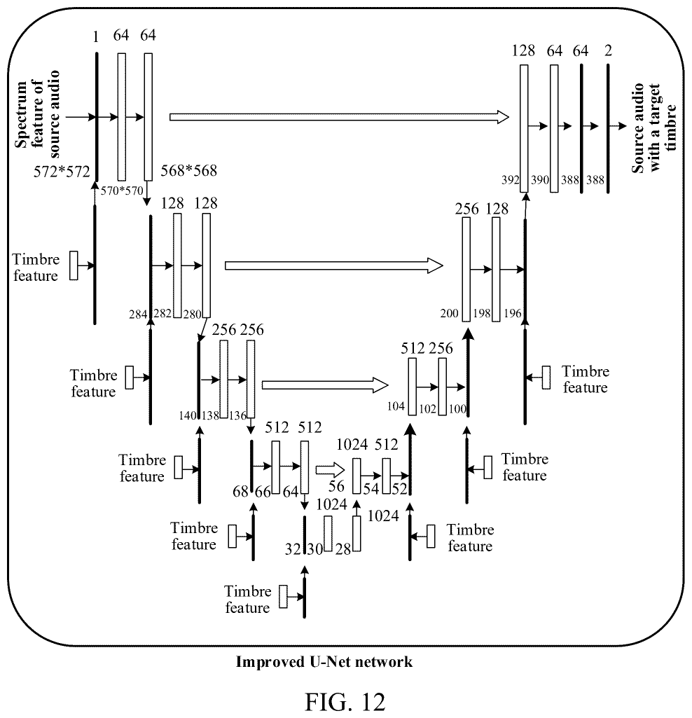

Next, the second module is described in detail. The timbre conversion model provided in this embodiment of the present disclosure is constructed by using the U-Net network. Referring to FIG. 12 (a number in FIG. 12 is a feature dimension), a typical characteristic of the U-Net network is that the U-Net network is a U-shaped symmetric structure, including a convolutional layer on the left, and an upsampling layer on the right. The U-Net network includes four convolutional layers and four corresponding upsampling layers. Therefore, during implementation, a weight of the U-Net network may be initialized from the beginning, and then the U-Net network model is trained. Alternatively, a convolutional layer structure of an existing network and a corresponding trained weight file may be used, and a subsequent upsampling layer may be added to perform training calculation. During deep learning model training, if the existing weight file can be used, the training speed can be greatly increased.

Another characteristic of the U-Net network is that a feature map obtained by each convolutional layer of the U-Net network is concatenated with a corresponding upsampling layer, thereby effectively using each layer of feature map in subsequent calculation, that is, skip-connection. In this way, features in a low-level feature map can be combined, so that a finally obtained feature map not only includes features in a high-level feature map but also includes features in the low-level feature map, thereby implementing integration of features in different scales, and improving the accuracy of a model result.

In this embodiment of the present disclosure, as shown in FIG. 12, the same embedding vector is added to each network layer in the U-Net network as an embedding, and the embedding vector is an identity timbre vector (e.g., the timbre feature) extracted by the foregoing first module. In this way, the identity timbre vector of the target object is embedded into each network layer, so that the entire timbre conversion model can deeply learn extracted identity timbre information of the target object, and calculation of each network layer can be close to a target timbre represented by the identity timbre vector. In actual application, an input of the second module may be a log-mel spectrum map of the source audio. The log-mel spectrum map is inputted as an image, and outputted to be reversely transformed into audio data, that is, the source audio with the target timbre.

Beneficial effects of applying the foregoing embodiment of the present disclosure include:
(1) This embodiment of the present disclosure is an audio timbre conversion method based on an object identity timbre vector embedding, to implement a fully-automated industrial timbre conversion system. It can automatically extract a timbre feature of a target identity timbre, and then automatically and rapidly perform timbre conversion on source audio based on the timbre feature. This can eliminate the inefficiencies of manual timbre conversion, enabling fast, large-scale, and high-efficiency industrial timbre conversion.
(2) This embodiment of the present disclosure is a timbre conversion model system constructed based on a deep learning neural network. The system needs to perform scientific systematic calculation to perform audio timbre conversion. Therefore, the timbre conversion of the system is a standardized result without any differentiation, thereby avoiding a differentiation phenomenon caused by different subjective feelings brought by manual timbre conversion.
(3) In this embodiment of the present disclosure, an identity timbre vector of a target object is used as timbre conversion information and transferred to a timbre conversion model, and the timbre conversion module performs timbre conversion on the source audio by using the transferred identity timbre vector. Therefore, this embodiment of the present disclosure can be used as a universal timbre conversion solution. Only the identity timbre vector of the target timbre needs to be extracted, and only a selected identity timbre vector needs to be transferred to the timbre conversion model to perform audio timbre conversion during use, which has universality and portability.
(4) In this embodiment of the present disclosure, rapid and efficient timbre conversion can be achieved without requiring large-scale timbre data of the target timbre for real-time model adjustment and training, and the identity timbre vector can be embedded into a plurality of layers of a timbre conversion model, to achieve a more accurate timbre conversion effect, thereby improving experience on an actual application of timbre conversion.
(5) The timbre conversion model in this embodiment of the present disclosure is improved and constructed based on a U-net network, and the extracted identity timbre vector can be accurately embedded into each layer of the U-net network, so that information about the target timbre can be perceived in features of each layer of timbre conversion, thereby improving the timbre conversion accuracy, and making a timbre of finally generated audio be more close to the target timbre.
(6) In this embodiment of the present disclosure, a model based on the improved PANNS and the Transformer module is used as an identity timbre vector extractor, so that audio features of the target object can be fully integrated in a time domain and a frequency domain. In this way, the extracted identity timbre vector is clearer, and correlation information between high and low frequencies is more accurate, thereby improving the effect of performing timbre conversion based on the identity timbre vector.

The following continues to describe an exemplary structure of the audio processing apparatus 555 provided in the embodiments of the present disclosure implemented as a software module. In some embodiments, as shown in FIG. 2, the software module stored in the audio processing apparatus 555 in the memory 550 may include: an obtaining module 5551, configured to obtain target audio with a first timbre, and obtain object audio of a target object; a first feature extraction module 5552, configured to perform timbre feature extraction on the object audio, to obtain a timbre feature of the object audio, the timbre feature being configured for representing a second timbre of the target object that is different from the first timbre; a second feature extraction module 5553, configured to perform audio feature extraction on the target audio, to obtain an audio feature of the target audio; and a timbre conversion module 5554, configured to generate target audio with the second timbre based on the timbre feature and the audio feature, to transform a timbre of the target audio from the first timbre into the second timbre.

In some embodiments, the first feature extraction module 5552 is further configured to perform frequency domain feature extraction on an audio frequency domain signal of the object audio, to obtain a frequency domain feature; perform timbre feature extraction on the frequency domain feature and an audio time domain signal of the object audio, to obtain an intermediate timbre feature of the object audio; and perform feature transformation processing on the intermediate timbre feature, to obtain the timbre feature of the object audio.

In some embodiments, the frequency domain feature includes a plurality of frequency domain sub-features, and the first feature extraction module 5552 is further configured to perform, for each frequency domain sub-feature, timbre feature extraction on the frequency domain sub-feature and the audio time domain signal of the object audio, to obtain a timbre sub-feature of the frequency domain sub-feature; and construct a timbre sub-feature sequence based on a plurality of timbre sub-features, and use the timbre sub-feature sequence as the intermediate timbre feature of the object audio.

In some embodiments, the first feature extraction module 5552 is further configured to perform first convolution processing on the frequency domain feature, to obtain a convolutional frequency domain feature; perform second convolution processing on the audio time domain signal of the object audio, to obtain a convolutional time domain feature; concatenate the convolutional frequency domain feature and the convolutional time domain feature, to obtain an audio concatenated feature; and perform timbre feature extraction on the audio concatenated feature, to obtain the intermediate timbre feature of the object audio.

In some embodiments, the first convolution processing includes M layers of convolution processing, and the second convolution processing includes N layers of convolution processing; the first feature extraction module 5552 is further configured to: before the concatenating the convolutional frequency domain feature and the convolutional time domain feature, to obtain an audio concatenated feature, obtain an intermediate convolutional frequency domain feature obtained by an m^{th} layer of convolution processing in the first convolution processing, and obtain an intermediate convolutional time domain feature obtained by an nth layer of convolution processing in the second convolution processing; and concatenate the intermediate convolutional frequency domain feature and the intermediate convolutional time domain feature, to obtain an intermediate audio concatenated feature; and the first feature extraction module 5552 is further configured to concatenate the convolutional frequency domain feature, the convolutional time domain feature, and the intermediate audio concatenated feature, to obtain the audio concatenated feature, where M, N, m, and n are integers greater than 1, m is less than M, and n is less than N.

In some embodiments, the first feature extraction module 5552 is further configured to perform convolution processing on the audio concatenated feature, to obtain a convolutional concatenated feature; determine a mean feature and a maximum feature of the convolutional concatenated feature, and determine a sum feature of the mean feature and the maximum feature; and perform timbre feature extraction on the sum feature, to obtain the intermediate timbre feature of the object audio.

In some embodiments, the first feature extraction module 5552 is further configured to encode the intermediate timbre feature, to obtain an encoded timbre feature; and decode the encoded timbre feature, to obtain the timbre feature of the object audio.

In some embodiments, the second feature extraction module 5553 is further configured to perform audio feature extraction on the target audio, to obtain one of the following audio features of the target audio: an audio frequency domain feature extracted from an audio frequency domain signal of the target audio; an audio time domain feature extracted from an audio time domain signal of the target audio; and a concatenated feature obtained by concatenating the audio frequency domain feature and the audio time domain feature.

In some embodiments, the timbre conversion module 5554 is further configured to concatenate the timbre feature and the audio feature, to obtain a first concatenated feature, and perform convolution processing on the first concatenated feature, to obtain a convolutional feature; and concatenate the convolutional feature and the timbre feature, to obtain a second concatenated feature, and perform upsampling processing on the second concatenated feature, to obtain the target audio with the second timbre.

In some embodiments, the timbre conversion module 5554 is further configured to generate the target audio with the second timbre based on the timbre feature and the audio feature by using a timbre conversion model, where the timbre conversion model includes J convolutional layers and J upsampling layers, and the timbre conversion module 5554 is further configured to determine, based on the timbre feature and the audio feature, a first layer of convolutional feature outputted by a first convolutional layer in the J convolutional layers, and concatenate the timbre feature and the first layer of convolutional feature, to obtain a first layer of concatenated feature; perform upsampling processing on the first layer of concatenated feature by using a first upsampling layer in the J upsampling layers, to obtain a first layer of upsampled feature; obtain a j^{th} layer of convolutional feature outputted by a j^{th} layer of convolutional layer in the J convolutional layers, and concatenate the timbre feature, the j^{th} layer of convolutional feature, and a (j−1)^{th} layer of upsampled feature, to obtain a j^{th} layer of concatenated feature; perform upsampling processing on the j^{th} layer of concatenated feature by using a j^{th} upsampling layer in the J upsampling layers, to obtain a j^{th} layer of upsampled feature, where J and j are integers greater than 1, and j is less than or equal to J; and traverse j, to obtain a J^{th} layer of upsampled feature, and use the J^{th} layer of upsampled feature as the target audio with the second timbre.

In some embodiments, the timbre conversion module 5554 is further configured to concatenate the timbre feature and the audio feature, to obtain a J^{th} layer of concatenated feature, and perform convolution processing on the J^{th} layer of concatenated feature by using a J^{th} layer of convolutional layer in the J convolutional layers, to obtain a J^{th} layer of convolutional feature; concatenate the timbre feature and a (j+1)^{th} layer of convolutional feature, to obtain a j^{th} layer of concatenated feature, and perform convolution processing on the j^{th} layer of concatenated feature by using a j^{th} layer of convolutional layer in the J convolutional layers, to obtain a j^{th} layer of convolutional feature; and traverse j, to obtain the first layer of convolutional feature outputted by the first convolutional layer in the J convolutional layers.

By applying the foregoing embodiments of the present disclosure, timbre feature extraction is first performed on object audio of a target object, to obtain a timbre feature of the object audio, the timbre feature being configured for representing a second timbre of the target object; and Then, timbre feature extraction is then performed on target audio with a first timbre, to obtain an audio feature of the target audio. Therefore, target audio with the second timbre can be generated based on the timbre feature and the audio feature, thereby transforming a timbre of the target audio from the first timbre into the second timbre. In this way, (1) the target audio can be automatically transformed from the first timbre into the second timbre of the target object according to the timbre feature of the object audio of the target object, thereby improving the audio timbre conversion efficiency; and (2) the transformation of the target audio from the first timbre into the second timbre is implemented according to the timbre feature of the object audio of the target object, thereby avoiding the impact of manual adjustment on timbre conversion, and making the transformed timbre of the target audio closer to the second timbre of the target object, thereby improving the timbre conversion effect.

An embodiment of the present disclosure further provides a computer program product. The computer program product includes computer-executable instructions. The computer-executable instructions are stored in a computer-readable storage medium. A processor of an electronic device reads the computer-executable instructions from the computer-readable storage medium, and the processor executes the computer-executable instructions, to cause the electronic device to perform the audio processing method provided in the embodiments of the present disclosure.

An embodiment of the present disclosure further provides a computer-readable storage medium. The computer-readable storage medium has computer-executable instructions stored therein. When the computer-executable instructions are executed by a processor, the processor is caused to perform the audio processing method provided in the embodiments of the present disclosure.

In some embodiments, the computer-readable storage medium may be a memory such as a RAM, a ROM, a flash memory, a magnetic surface memory, an optical disc, or a CD-ROM; and may alternatively be various devices including one of the foregoing memories or any combination thereof.

In some embodiments, the computer-executable instructions may be in the form of programs, software, software modules, scripts, or code written in any form of programming language (including compiled or interpreted languages, or declarative or procedural languages), and can be deployed in any form, for example, deployed as a stand-alone program or as a module, component, subroutine, or other units suitable for usage in a computing environment.

As an example, the computer-executable instructions may, but not necessarily, correspond to a file in a file system, and may be stored in a part of the file that stores other programs or data, for example, stored in one or more scripts in a hyper text markup language (HTML) document, stored in a single file dedicated to the program under discussion, or stored in a plurality of collaborative files (for example, a file that stores one or more modules, subroutines, or code parts).

As an example, the computer-executable instructions can be deployed to be executed on one electronic device, or on a plurality of electronic devices located at one site, or on a plurality of electronic devices distributed across a plurality of sites and interconnected by a communication network.

The embodiments of the present disclosure have the following beneficial effects.

For example, by applying the foregoing embodiments of the present disclosure, timbre feature extraction is first performed on object audio of a target object, to obtain a timbre feature of the object audio, the timbre feature being configured for representing a second timbre of the target object; and timbre feature extraction is then performed on target audio with a first timbre, to obtain an audio feature of the target audio. Therefore, target audio with the second timbre can be generated based on the timbre feature and the audio feature, thereby transforming the timbre of the target audio from the first timbre into the second timbre. In this way, (1) the target audio can be automatically transformed from the first timbre into the second timbre of the target object according to the timbre feature of the object audio of the target object, thereby improving the audio timbre conversion efficiency; and (2) the transformation of the target audio from the first timbre into the second timbre is implemented according to the timbre feature of the object audio of the target object, thereby avoiding the impact of manual adjustment on timbre conversion, and making the transformed timbre of the target audio closer to the second timbre of the target object, thereby improving the timbre conversion effect.

The foregoing descriptions are merely embodiments of the present disclosure and are not intended to limit the protection scope of the present disclosure. Any modification, equivalent replacement, and improvement made within the spirit and scope of the present disclosure all fall within the protection scope of the present disclosure.

What is claimed is:

1. An audio processing method, applied to an electronic device, the method comprising:
obtaining target audio with a first timbre, and obtaining object audio of a target object;
performing timbre feature extraction on the object audio, to obtain a timbre feature of the object audio, the timbre feature being configured for representing a second timbre of the target object that is different from the first timbre;
performing audio feature extraction on the target audio, to obtain an audio feature of the target audio; and
generating target audio with the second timbre based on the timbre feature and the audio feature.

2. The method according to claim 1, wherein performing the timbre feature extraction on the object audio, to obtain the timbre feature of the object audio comprises:
performing frequency domain feature extraction on an audio frequency domain signal of the object audio, to obtain a frequency domain feature;
performing timbre feature extraction on the frequency domain feature and an audio time domain signal of the object audio, to obtain an intermediate timbre feature of the object audio; and
performing feature transformation processing on the intermediate timbre feature, to obtain the timbre feature of the object audio.

3. The method according to claim 2, wherein the frequency domain feature comprises a plurality of frequency domain sub-features, and performing the timbre feature extraction on the frequency domain feature and the audio time domain signal of the object audio, to obtain the intermediate timbre feature of the object audio comprises:
performing, for a frequency domain sub-feature, timbre feature extraction on the frequency domain sub-feature and the audio time domain signal of the object audio, to obtain a timbre sub-feature of the frequency domain sub-feature; and
constructing a timbre sub-feature sequence based on the plurality of timbre sub-features, and using the timbre sub-feature sequence as the intermediate timbre feature of the object audio.

4. The method according to claim 2, wherein performing the timbre feature extraction on the frequency domain feature and the audio time domain signal of the object audio, to obtain the intermediate timbre feature of the object audio comprises:
performing first convolution processing on the frequency domain feature, to obtain a convolutional frequency domain feature;
performing second convolution processing on the audio time domain signal of the object audio, to obtain a convolutional time domain feature;
concatenating the convolutional frequency domain feature and the convolutional time domain feature, to obtain an audio concatenated feature; and
performing timbre feature extraction on the audio concatenated feature, to obtain the intermediate timbre feature of the object audio.

5. The method according to claim 4, wherein the first convolution processing comprises M layers of convolution processing, and the second convolution processing comprises N layers of convolution processing;
the method further comprises:
obtaining an intermediate convolutional frequency domain feature obtained by an m^{th} layer of convolution processing in the first convolution processing, and obtaining an intermediate convolutional time domain feature obtained by an nth layer of convolution processing in the second convolution processing; and
concatenating the intermediate convolutional frequency domain feature and the intermediate convolutional time domain feature, to obtain an intermediate audio concatenated feature; and
the concatenating the convolutional frequency domain feature and the convolutional time domain feature, to obtain an audio concatenated feature comprises:
concatenating the convolutional frequency domain feature, the convolutional time domain feature, and the intermediate audio concatenated feature, to obtain the audio concatenated feature, wherein
M, N, m, and n are integers greater than 1, m is less than M, and n is less than N.

6. The method according to claim 4, wherein performing the timbre feature extraction on the audio concatenated feature, to obtain the intermediate timbre feature of the object audio comprises:
performing convolution processing on the audio concatenated feature, to obtain a convolutional concatenated feature;
determining a mean feature and a maximum feature of the convolutional concatenated feature, and determining a sum feature of the mean feature and the maximum feature; and
performing timbre feature extraction on the sum feature, to obtain the intermediate timbre feature of the object audio.

7. The method according to claim 2, wherein performing the feature transformation processing on the intermediate timbre feature, to obtain the timbre feature of the object audio comprises:
encoding the intermediate timbre feature, to obtain an encoded timbre feature; and
decoding the encoded timbre feature, to obtain the timbre feature of the object audio.

8. The method according to claim 1, wherein performing the audio feature extraction on the target audio, to obtain the audio feature of the target audio comprises:
performing audio feature extraction on the target audio, to obtain one of following audio features of the target audio:
an audio frequency domain feature extracted from an audio frequency domain signal of the target audio;
an audio time domain feature extracted from an audio time domain signal of the target audio; and
a concatenated feature obtained by concatenating the audio frequency domain feature and the audio time domain feature.

9. The method according to claim 1, wherein generating the target audio with the second timbre based on the timbre feature and the audio feature comprises:
concatenating the timbre feature and the audio feature, to obtain a first concatenated feature, and performing convolution processing on the first concatenated feature, to obtain a convolutional feature; and
concatenating the convolutional feature and the timbre feature, to obtain a second concatenated feature, and performing upsampling processing on the second concatenated feature, to obtain the target audio with the second timbre.

10. The method according to claim 1, wherein generating the target audio with the second timbre based on the timbre feature and the audio feature comprises: generating the target audio with the second timbre based on the timbre feature and the audio feature by using a timbre conversion model, wherein
the timbre conversion model comprises J convolutional layers and J upsampling layers, and generating the target audio with the second timbre based on the timbre feature and the audio feature by using a timbre conversion model comprises:
determining, based on the timbre feature and the audio feature, a first layer of convolutional feature outputted by a first convolutional layer in the J convolutional layers, and concatenating the timbre feature and the first layer of convolutional feature, to obtain a first layer of concatenated feature;
performing upsampling processing on the first layer of concatenated feature by using a first upsampling layer in the J upsampling layers, to obtain a first layer of upsampled feature;
obtaining a j^{th} layer of convolutional feature outputted by a j^{th} layer of convolutional layer in the J convolutional layers, and concatenating the timbre feature, the j^{th} layer of convolutional feature, and a (j−1)^{th} layer of upsampled feature, to obtain a j^{th} layer of concatenated feature;
performing upsampling processing on the j^{th} layer of concatenated feature by using a j^{th} upsampling layer in the J upsampling layers, to obtain a j^{th} layer of upsampled feature, wherein J and j are integers greater than 1, and j is less than or equal to J; and
traversing j, to obtain a J^{th} layer of upsampled feature, and using the J^{th} layer of upsampled feature as the target audio with the second timbre.

11. The method according to claim 10, wherein determining, based on the timbre feature and the audio feature, the first layer of the convolutional feature outputted by the first convolutional layer in the J convolutional layers comprises:
concatenating the timbre feature and the audio feature, to obtain a J^{th} layer of concatenated feature, and performing convolution processing on the J^{th} layer of concatenated feature by using a J^{th} layer of convolutional layer in the J convolutional layers, to obtain a J^{th} layer of convolutional feature;
concatenating the timbre feature and a (j+1)^{th} layer of convolutional feature, to obtain a j^{th} layer of concatenated feature, and performing convolution processing on the j^{th} layer of concatenated feature by using a j^{th} layer of convolutional layer in the J convolutional layers, to obtain a j^{th} layer of convolutional feature; and
traversing j, to obtain the first layer of convolutional feature outputted by the first convolutional layer in the J convolutional layers.

12. An electronic device, comprising:
one or more processors and a memory containing computer-executable instructions that, when being executed, cause the one or more processors to perform:
obtaining target audio with a first timbre, and obtaining object audio of a target object;
performing timbre feature extraction on the object audio, to obtain a timbre feature of the object audio, the timbre feature being configured for representing a second timbre of the target object that is different from the first timbre;
performing audio feature extraction on the target audio, to obtain an audio feature of the target audio; and
generating target audio with the second timbre based on the timbre feature and the audio feature.

13. The device according to claim 12, wherein the one or more processors are further configured to perform:
performing frequency domain feature extraction on an audio frequency domain signal of the object audio, to obtain a frequency domain feature;
performing timbre feature extraction on the frequency domain feature and an audio time domain signal of the object audio, to obtain an intermediate timbre feature of the object audio; and
performing feature transformation processing on the intermediate timbre feature, to obtain the timbre feature of the object audio.

14. The device according to claim 13, wherein the frequency domain feature comprises a plurality of frequency domain sub-features, and the one or more processors are further configured to perform:
performing, for a frequency domain sub-feature, timbre feature extraction on the frequency domain sub-feature and the audio time domain signal of the object audio, to obtain a timbre sub-feature of the frequency domain sub-feature; and
constructing a timbre sub-feature sequence based on the plurality of timbre sub-features, and using the timbre sub-feature sequence as the intermediate timbre feature of the object audio.

15. The device according to claim 13, wherein the one or more processors are further configured to perform:
performing first convolution processing on the frequency domain feature, to obtain a convolutional frequency domain feature;
performing second convolution processing on the audio time domain signal of the object audio, to obtain a convolutional time domain feature;
concatenating the convolutional frequency domain feature and the convolutional time domain feature, to obtain an audio concatenated feature; and
performing timbre feature extraction on the audio concatenated feature, to obtain the intermediate timbre feature of the object audio.

16. The device according to claim 15, wherein the first convolution processing comprises M layers of convolution processing, and the second convolution processing comprises N layers of convolution processing; and
the one or more processors are further configured to perform:
obtaining an intermediate convolutional frequency domain feature obtained by an m^{th} layer of convolution processing in the first convolution processing, and obtaining an intermediate convolutional time domain feature obtained by an nth layer of convolution processing in the second convolution processing; and
concatenating the intermediate convolutional frequency domain feature and the intermediate convolutional time domain feature, to obtain an intermediate audio concatenated feature; and
the concatenating the convolutional frequency domain feature and the convolutional time domain feature, to obtain an audio concatenated feature comprises:
concatenating the convolutional frequency domain feature, the convolutional time domain feature, and the intermediate audio concatenated feature, to obtain the audio concatenated feature, wherein
M, N, m, and n are integers greater than 1, m is less than M, and n is less than N.

17. The device according to claim 15, wherein the one or more processors are further configured to perform:
performing convolution processing on the audio concatenated feature, to obtain a convolutional concatenated feature;
determining a mean feature and a maximum feature of the convolutional concatenated feature, and determining a sum feature of the mean feature and the maximum feature; and
performing timbre feature extraction on the sum feature, to obtain the intermediate timbre feature of the object audio.

18. The device according to claim 13, wherein the one or more processors are further configured to perform:
encoding the intermediate timbre feature, to obtain an encoded timbre feature; and
decoding the encoded timbre feature, to obtain the timbre feature of the object audio.

19. The device according to claim 12, wherein the one or more processors are further configured to perform:
performing audio feature extraction on the target audio, to obtain one of following audio features of the target audio:
an audio frequency domain feature extracted from an audio frequency domain signal of the target audio;
an audio time domain feature extracted from an audio time domain signal of the target audio; and
a concatenated feature obtained by concatenating the audio frequency domain feature and the audio time domain feature.

20. A non-transitory computer-readable storage medium containing computer-executable instructions that, when being executed, cause at least one processor to perform:
obtaining target audio with a first timbre, and obtaining object audio of a target object;
performing timbre feature extraction on the object audio, to obtain a timbre feature of the object audio, the timbre feature being configured for representing a second timbre of the target object that is different from the first timbre;
performing audio feature extraction on the target audio, to obtain an audio feature of the target audio; and
generating target audio with the second timbre based on the timbre feature and the audio feature.
